(19) United States
(12) Patent Application Publication
(10) Pub. No.: US 2009/0296217 A1
(43) Pub. Date: Dec. 3, 2009

(54) IMAGE BLUR CORRECTION DEVICE

(75) Inventor: Yaw-Ching Huang, Taichung (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASIA OPTICAL CO., INC., Taichung (TW)

(21) Appl. No.: 12/477,249

(22) Filed: Jun. 3, 2009

(30) Foreign Application Priority Data
Jun. 3, 2008 (TW) 97120578

(51) Int. Cl. G02B 27/64

(52) U.S. Cl. 359/554

(57) ABSTRACT

An image blur correction device includes a base, a seat disposed on the base, an image detecting unit disposed on the seat, at least one coil, and at least one magnet. The coil is disposed on the seat or the base, has a first length in a first direction and a second length in a second direction, and has a hollow portion. The first direction is perpendicular to the second direction. The magnet is disposed on the seat or the base and opposite to the coil, and has a third length in the first direction corresponding to the first length and a fourth length in the second direction corresponding to the second length. The coil moves relative to the magnet and has a maximum moving distance so that the seat moves relative to the base. A width of the hollow portion equals to or exceeds twice the maximum moving distance.

### CROSS REFERENCE TO RELATED APPLICATIONS

This application claims priority of Taiwan Patent Application No. 97120578, filed on Jun. 3, 2008, the entirety of which is incorporated by reference herein.

### BACKGROUND OF THE INVENTION

1. Field of the Invention

The present invention relates to an image blur correction device, and in particular relates to an image blur correction device with a movable optical element to prevent a blur.

2. Description of the Related Art

Referring to FIG. 1, U.S. Pat. No. 5,266,988 discloses an image shake suppressing device for a camera. The image shake suppressing device is mounted in a lens. When the camera is used, an angular velocity meter measures the angular velocity of the shaking camera and provides the measured data to a circuit which calculates the data for a driving part to move the lens in a direction of a vertical optical axis, thereby compensating or suppressing blurring due to vibration of the camera.

Because the lens, however, is moved along a vertical optical axis, the ambient light and MTF value thereof are reduced. Thus, the compensation method has limited compensation effect and may reduce image quality.

Referring to FIGS. 2A and 2B, Japan patent No. 3551174 discloses a moving mechanism. The moving mechanism is applicable to any lens and employs piezoelectric elements to drive an image detecting unit, such as a CCD, in a vertical direction, such that blur can be compensated or suppressed.

The piezoelectric elements must be driven by voltage to move the CCD. As the CCD, is heavier than a single lens, a large piezoelectric element is needed to avoid deterioration of the image quality. Thus, the volume of the camera is increased.

U.S. Pat. No. 6,327,433 discloses an assembly of a coil and two magnets, moving a compensation lens to compensate for hand shake. Poles of the two magnets are disposed face to face to from a closed magnetic circuit and the coil is disposed between the two magnets. During operation, the coil can be moved by a force generated from a magnetic flux of the magnet circuit and the current passing through the coil. In this patent, however, the movement of the coil is not limited. Thus, during movement of the coil, a part of the coil may not face the magnet, so that magnetic flux passing through the coil is reduced, and the movement of the coil and the compensation lens can not be accurately controlled.

### BRIEF SUMMARY OF THE INVENTION

An image blur correction device of the invention provides a predetermined relationship between a width of a coil, a width of a magnet, and a maximum moving distance. When the coil is moved relative to the magnet, a magnetic flux passing though the coil is held at a maximum level to accurately control the motion of the image detecting device for minimizing or preventing a blur.

An embodiment of an image blur correction device of the invention comprises a base, a seat, an image detecting unit, at least one coil, and at least one magnet. The seat is disposed on the base. The image detecting unit is disposed on the seat. The coil is disposed on the seat or the base, has a first length in a first direction and a second length in a second direction, and has a hollow portion, wherein the first direction is perpendicular to the second direction. The magnet is disposed on the seat or the base and opposite to the coil, and has a third length in the first direction corresponding to the first length and a fourth length in the second direction corresponding to the second length, wherein the coil moves relative to the magnet and has a maximum moving distance so that the seat moves relative to the base. A width of the hollow portion is equal to or greater than twice the maximum moving distance.

In the foregoing embodiment of the invention, the first length is smaller than the third length and a difference between the first length and the third length is greater than or equal to the maximum moving distance.

In the foregoing embodiment of the invention, the second length is smaller than the fourth length and a difference between the second length and the fourth length is greater than or equal to the maximum moving distance.

In the foregoing embodiment of the invention, the magnet comprises an N pole and an S pole, disposed in the first direction.

The foregoing embodiment of the invention further comprises a Hall element disposed on either the base or the seat and adjacent to the coil, wherein a magnetic force is generated between the coil and the magnet by providing a voltage to the coil, moving the seat in the first direction.

The foregoing embodiment of the invention further comprises a guide member by which the seat is joined to the base, and movable relative to the base in the first direction. The guide member comprises a plurality of holding portions and a pair of shafts. The holding portions are disposed on the base and the seat, respectively. The parallel shafts are held by the holding portions, whereby the seat is joined to the base, and movably along the shaft.

In the foregoing embodiment of the invention, when the image detecting module is still, two halves of the Hall element are located on the N pole and the S pole of the magnet, respectively.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 depicts an image shake suppressing device disclosed in U.S. Pat. No. 5,266,988;

FIGS. 2A and 2B depict a moving mechanism disclosed in Japan Patent No. 3551174;

FIG. 3 is a perspective view of an embodiment of an image detecting module of the invention;

FIG. 4 is a rear view of a base of the image detecting module;

FIG. 5 is a perspective view of a seat with a movable plate of the embodiment of the invention;

FIG. 6 is a rear view of a seat with a movable plate of the embodiment of the invention;

FIG. 7A is an assembly drawing of a first coil and a first magnet and depicts the first coil moving in a positive Y direction;

FIG. 7B is an assembly drawing of a first coil and a first magnet and depicts the centerlines of the first coil and the first magnet;

FIG. 7C is an assembly drawing of a first coil and a first magnet and depicts the first coil moving in a negative Y direction;

FIGS. 8A, 8B, and 8C are side views of FIGS. 7A, 7B, and 7C.

FIGS. 9A, 9B, and 9C are top views of FIGS. 7A, 7B, and 7C.

FIG. 10 is a schematic view of a camera having the image detecting module of the invention.

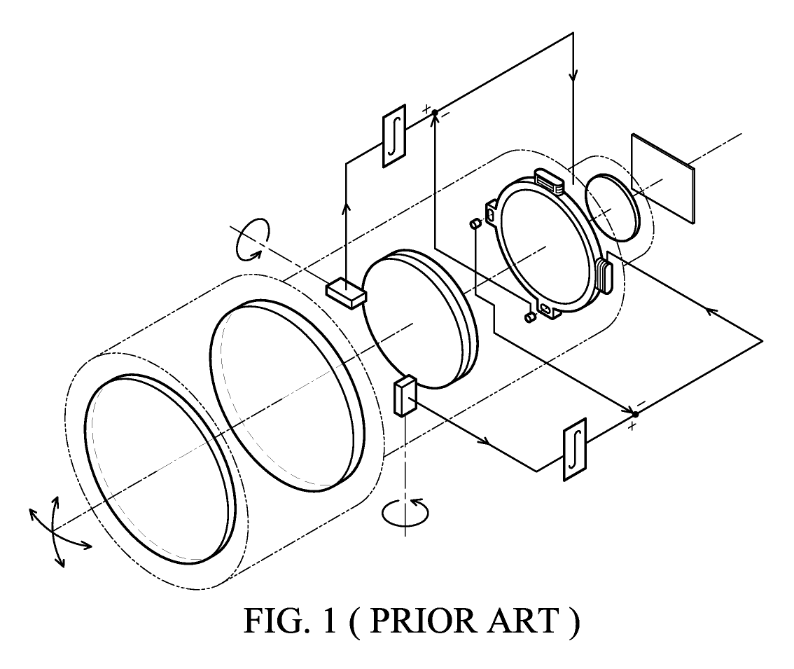

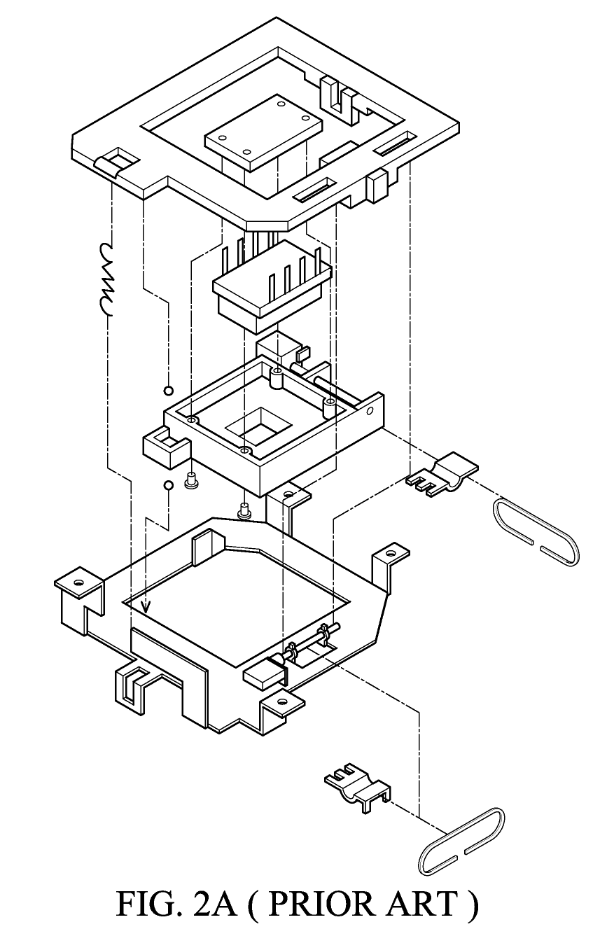

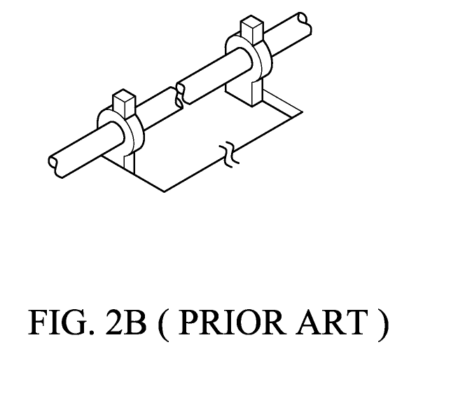

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

In the following description, the orientations, such as first direction X, second direction Y, or third direction Z, are based on the coordinates in each figure, and the first direction X, second direction Y, and the third direction Z are orthogonal to each other.

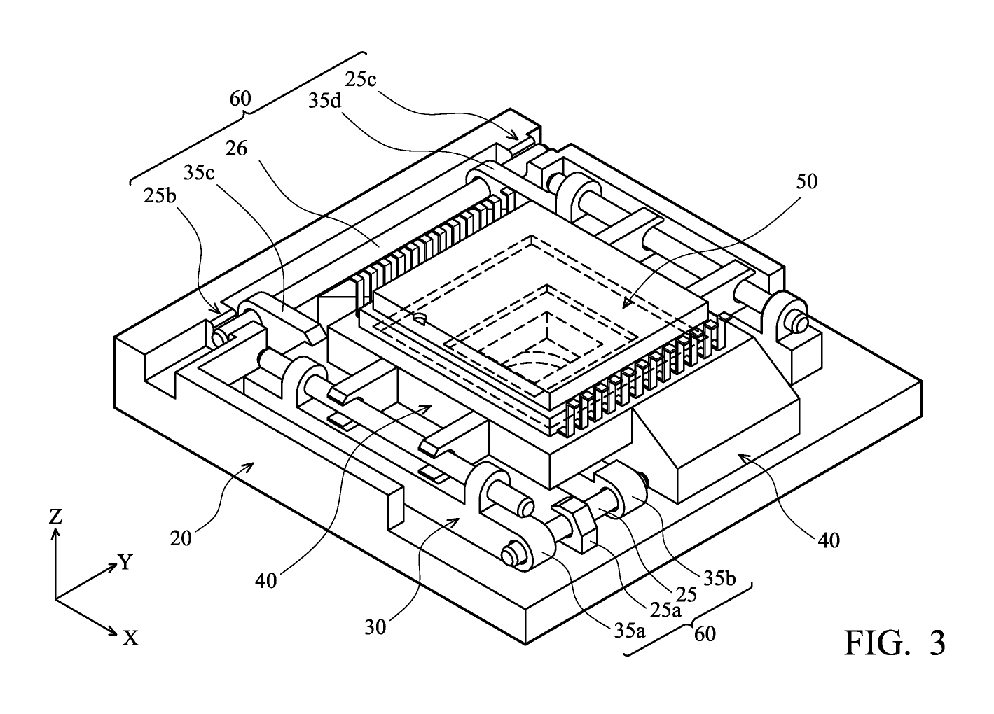

Referring to FIG. 3, an image detecting module of an embodiment of the invention is applicable in cameras for suppressing and compensating a blur arising from hand shake. The image detecting module comprises a base 20 with a hollow portion 29, a seat 30 disposed in the hollow portion 29, a movable plate 40 detachable disposed in the seat 30, and an image detecting unit 50 (such as a CCD) disposed on the movable plate 40. The sensing surface of the image detecting unit 50 faces opposite to the third direction Z.

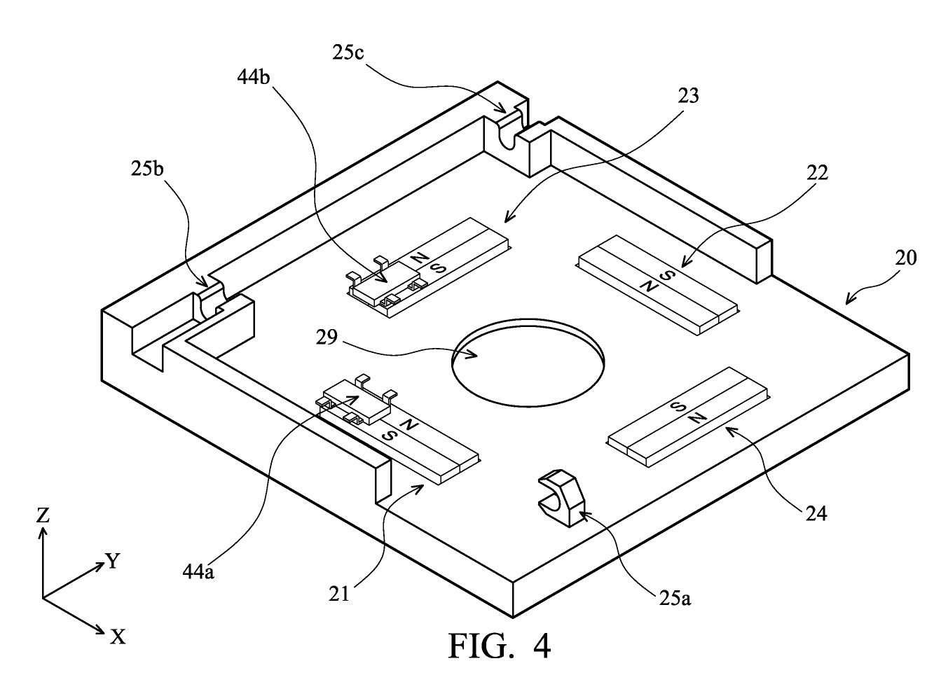

Referring to FIG. 4, the base 20 comprises a pair of first magnets 21 and 22, a pair of second magnets 23 and 24 and a pair of parallel first shafts 25 and 26. The first magnets 21 and 22 are disposed in parallel on two sides of the hollow portion 29. The N pole and S pole of the first magnet 21 are extended in the first direction X, and the N pole and S pole of the first magnet 22 are also extended in the first direction X. The second magnets 23 and 24 are disposed in parallel on two sides of the hollow portions 29. The N pole and the S pole of the second magnet 23 are extended in the second direction Y, and the N pole and the S pole of the other second magnet 24 are also extended in the second direction Y. In addition, N poles of the first magnet 21 and 22 face the hollow portion 29, and the S poles of the second magnet 23 and 24 face the hollow portion 29.

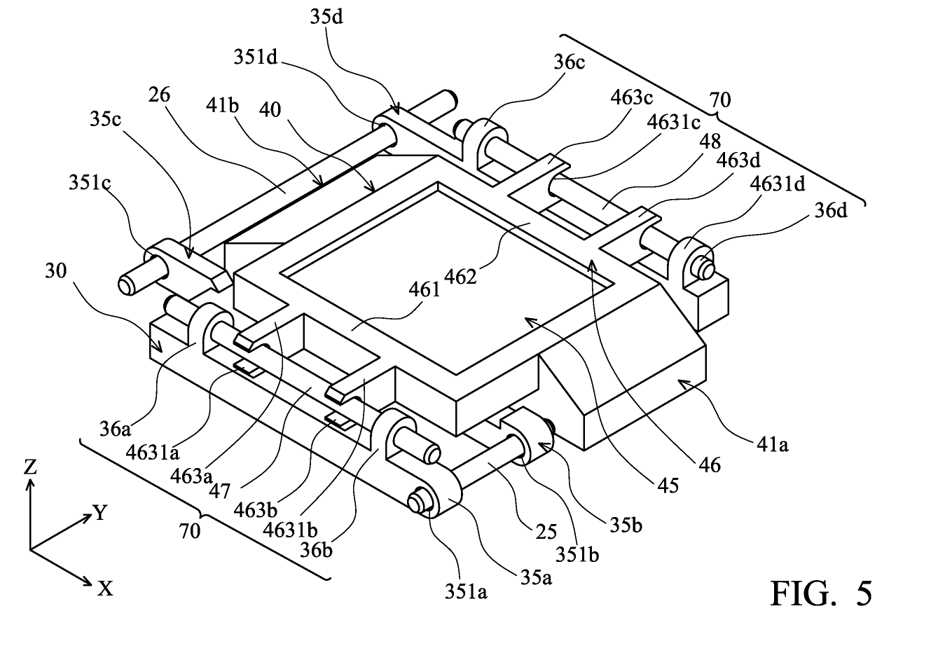

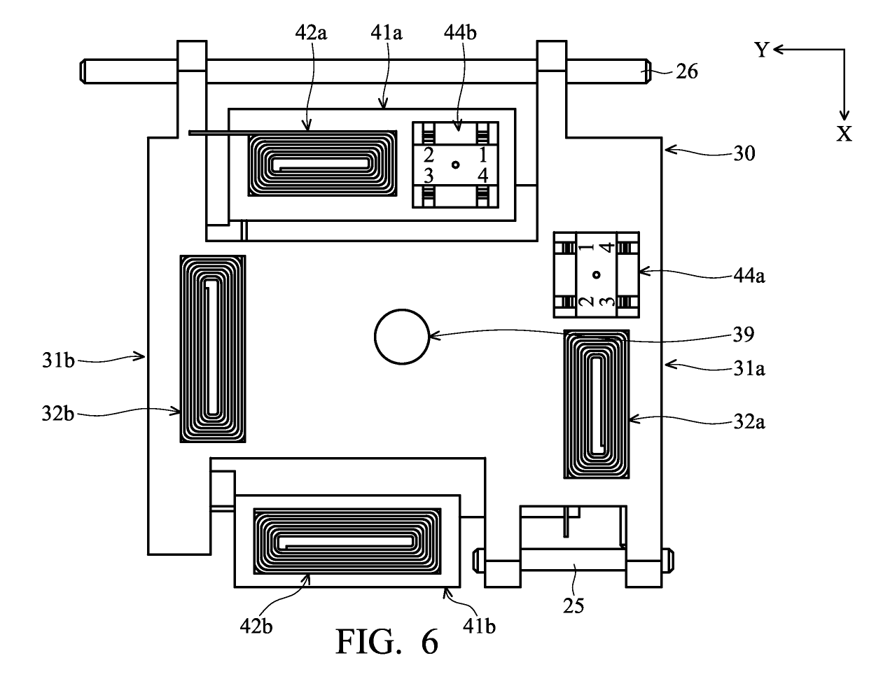

Referring to FIGS. 5 and 6, the seat 30 has two wing portions 31a and 31b, with a pair of first coils 32a and 32b and a first Hall element 44a disposed thereon. Specifically, the first coil 32a is disposed on the wing portion 31a, the first Hall element 44a is also disposed on the wing portion 31a and adjacent to the first coil 32a, and the other first coil 32b is disposed on the wing portion 31b. The first coils 32a and 32b are substantially rectangular and their longitudinal sides are parallel. The movable plate 40 also has two wing portions 41a and 41b. A pair of second coils 42a and 42b and a second Hall element 44b are disposed on the wing portions 41a and 41b. Specifically, the second coil 42a is disposed on the wing portion 41a, the second Hall element 44b is disposed on the wing portion 41a and adjacent to the second coil 42a, and the other second coil 42b is also disposed on the wing portion 41b. The second coils 42a and 42b are also substantially rectangular, and their longitudinal sides are parallel. A pair of first holding portions 35a and 35b is disposed on the seat 30 adjacent to the wing portion 41a. The first holding portions 35a and 35b have holes 351a and 351b, respectively. Also, a pair of first holding portions 35c and 35d is disposed on the seat 30 adjacent to another wing portion 41b. The first holding portion 35c and 35d has holes 351c and 351d.

A pair of first shafts 25 and 26 is disposed in parallel. The shorter first shaft 25 is disposed on the side of the magnets 21 and 24, while the longer first shaft 26 is disposed on the side of the magnet 23 away from the hollow portion 29. In this embodiment, the longer first shaft 26 extends through the holes 351c and 351d and is held by the first holding portions 35c and 35d and is fixed to the holding portions 25b and 25c. The shorter first shaft 25 extends through holes 351a and 351b and is fixed by the holding portion 25a. The first shafts 25, 26 and the holding portions 25a, 25b, 25c, 35a, 35b, 35c, and 35d constitute a first guide element 60 through which the seat 30 can be moved in the second direction Y.

Referring to FIGS. 5 and 6, the seat 30 has a hollow portion 39. The image detecting unit 50 is disposed in the hollow portion 30 on the movable plate 40. The movable plate 40 has a circuit board 45 to which the image detecting unit 50 is electrically connected. A rectangular frame 46 is fixed to the circuit board 45 and surrounds the image detecting unit 50. A pair of parallel frame walls 461 and 462 of the rectangular frame 46 have second holding portions 463a, 463b, 463c and 463d, respectively. The second holding portions 463a, 463b, 463c and 463d have holes 4631a, 4631b, 4631c and 4631d, respectively. A pair of second shafts 47 and 48 is parallel to the first direction X. One of the second shafts 47 extends through the holding portion 36a and 36b on the seat 30 and is inserted into holes 4631a and 4631b and fixed to the seat 30. The other second shaft 48 extends through the holding portions 36c and 36d and holes 4631c and 4631d, whereby the movable plate 40 is joined to the seat 30. The second shafts 47, 48 and the holding portions 36a, 36b, 36c, 36d, 463a, 463b, 463c, and 463d constitute a second guide element 70 through which a movable plate 40 can be moved in the first direction X.

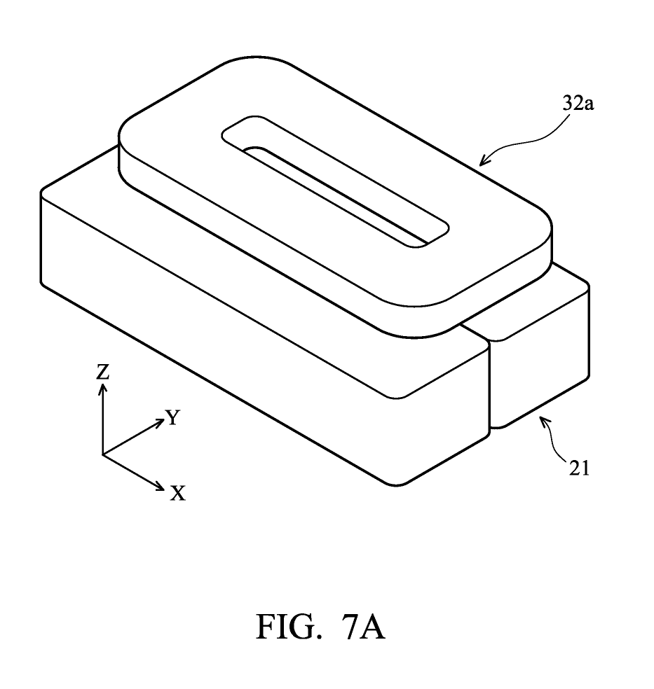

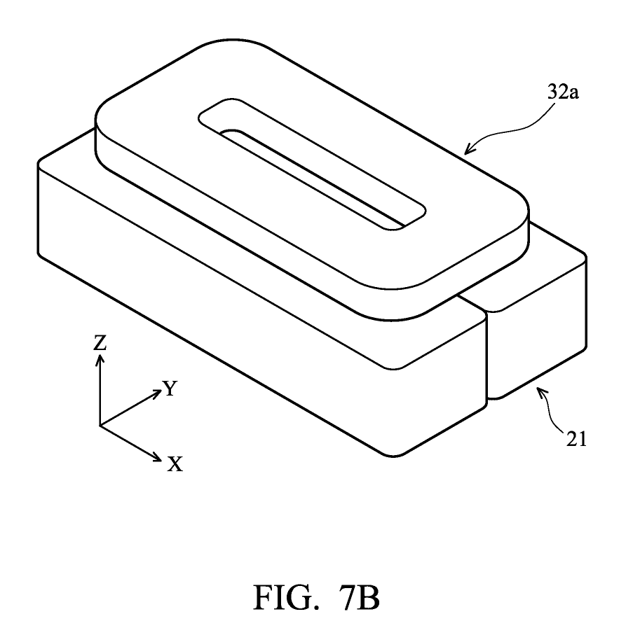

FIGS. 7A, 7B, and 7C depict the first coil 32a and the first magnet 21, wherein the assembly of the first coil 32b and the first magnet 22, the assembly of the second coil 42a and the second magnet 23, and the assembly of the second coil 42b and the second magnet 24 are similar to that of the first coil 32a and the first magnet 21. Thus, only the assembly of the first coil 32a and the first magnet 21 is described.

FIG. 7B depicts the first coil 32a and the first magnet 21 with superimposed centerlines, and FIGS. 7A and 7C depict the first coil 31 moving in a positive Y direction and a negative Y direction, respectively.

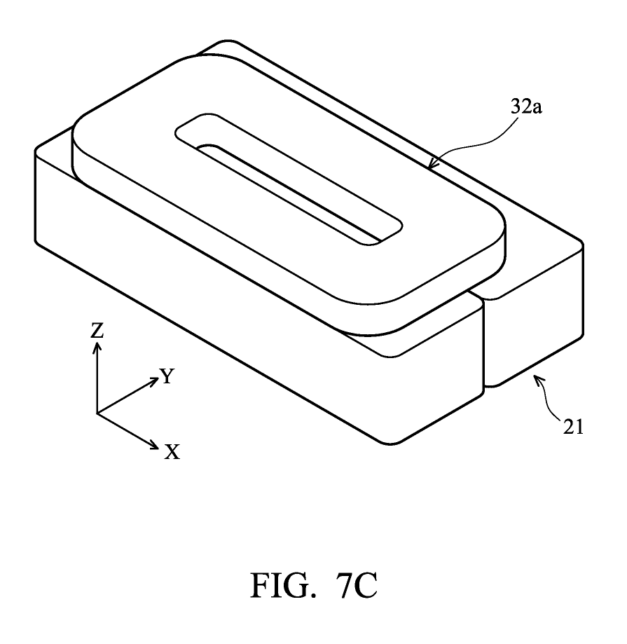

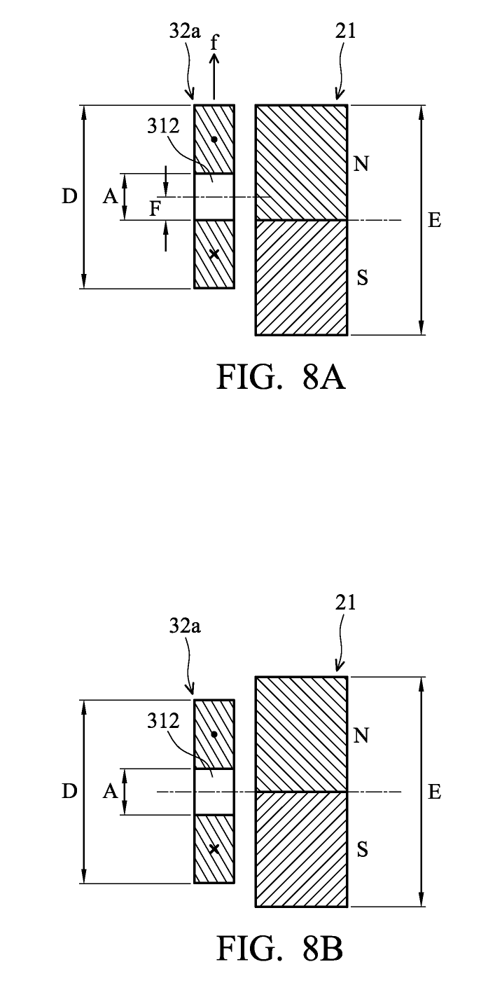

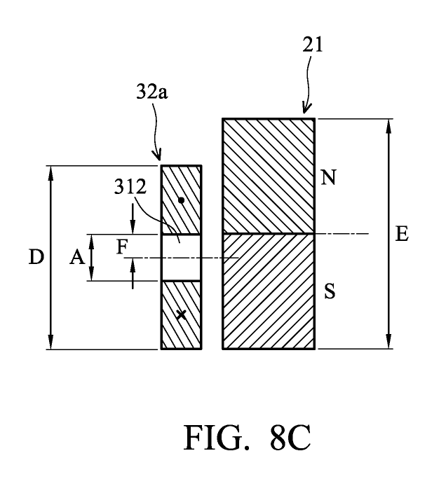

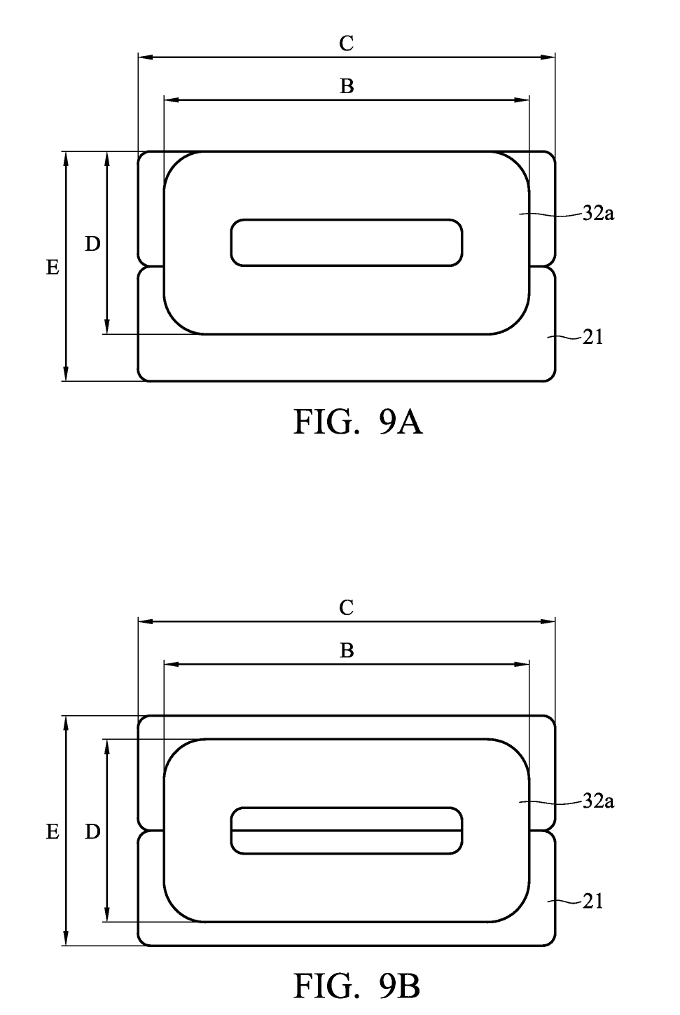

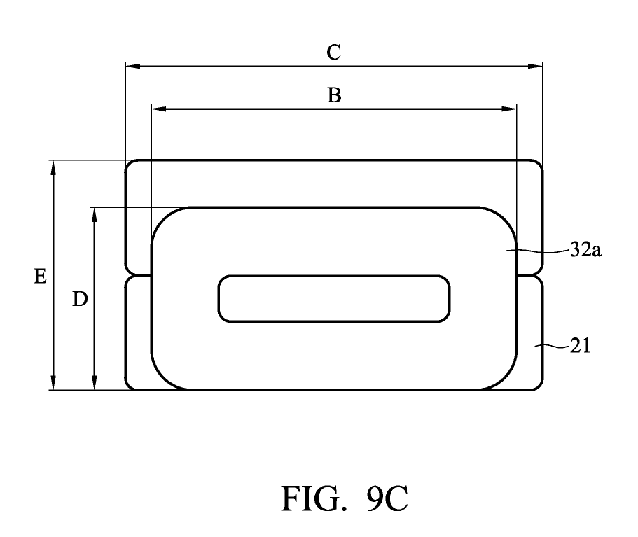

FIGS. 8A, 8B, and 8C are side views of FIGS. 7A, 7B, and 7C. FIGS. 9A, 9B, and 9C are top views of FIGS. 7A, 7B, and 7C.

The N pole and S pole of the first magnet 21 are adjoined. The first coil 32a has a hollow portion 312, wherein a width of the hollow portion 312 is A. The first coil 32a has a first length B in the first direction X and a second length D in the second direction Y. The first magnet 21 has a third length C in the first direction X and a fourth length E in the second direction Y.

Referring to FIGS. 8A, 8B, and 8C, “.” indicates the direction of the current out of the paper containing FIG. 8A, 8B, or 8C, and “x” indicates the direction of the current into the paper containing FIG. 8A, 8B, or 8C. When the first coil 32a is moved the maximum distance, the current passes in direction “.” through the part of the first coil 32a, which is located in the magnetic field of the N pole of the first magnet 21 to generate an upward force, and the current passes in direction “x” through the part of the first coil 32a, which is located in the magnetic field of the S pole of the first magnet 21 to generate an upward force, and thus the first coil 32a is moved upwardly. If F>A/2, then the part of the first coil 32a having the current in direction “x” will enter the magnetic field of the N pole of the first magnet 21, so that the first coil 32a generates a downward force to counteract the upward force f, thus affecting movement of the first coil 32a. A downward moving status of the first coil 32 is similar to an upward moving status thereof. Thus, the maximum distance F of the first coil 32a of the invention is limited to be smaller than or equal to A/2, that is A≧2F.

Referring to 9A, 9B, and 9C, the second length D of the first coil 31 is smaller than the fourth length E of the first magnet 21, and a difference between the second length D and the fourth length E is greater than or equal to a maximum moving distance F.

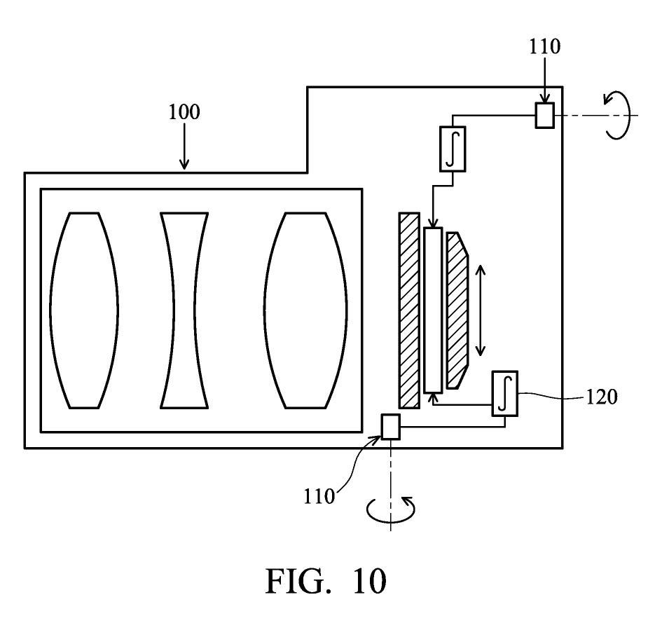

FIG. 10 depicts a camera employing the image detecting unit of the invention. Referring to FIGS. 3 and 10, a camera 100 comprises a motion sensor 110, such as an angular acceleration element or linear acceleration element. When the motion sensor 110 detects motion of the camera 100, a PWM circuit 120 or a digital circuit provides a voltage signal to the first coils 32a, 32b and the second coils 42a and 42b. The first coils 32a, 32b and the second coils 42a, 42b generate variable magnetic fields which interact with the first magnet 21, 22 and the second magnet 23, 24, whereby the seat 30 moves in the second direction Y, the movable plate 40 moves in the first direction X, and the image detecting unit 50 moves in the first direction X and the second direction Y, correspondingly. Blurring is thereby minimized or prevented.

When the camera 100 is still, the image detecting module is also still. At this time, two halves of the first Hall element 44a are located on the N pole and the S pole of the first magnet 21, and two halves of the second Hall element 44b are located on the N pole and the S pole of the second magnet 23. Thus, the first and second Hall elements 44a and 44b detect no magnetic field variation. When the camera 100 is shaken during operation, the first and second coils 42a, 42b, 43a, 43b interact with the first and second magnets 21, 22, 23 and 24 to move the seat 30 in the first direction X and the second direction Y. The Hall element 44a and 44b detects variation of the magnetic field to calculate the displacement and moving frequency of the seat 30, whereby the voltage signal from the PWM circuit and the digital circuit is modified.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image blur connection device, comprising
a base;
a seat disposed on the base;
an image detecting unit disposed on the seat;
at least one coil disposed on the seat, having a first length in a first direction and a second length in a second direction, and having a hollow portion, wherein the first direction is perpendicular to the second direction; and
at least one magnet disposed on the base and opposite to the coil, and having a third length in the first direction corresponding to the first length and a fourth length in the second direction corresponding to the second length, wherein the coil moves relative to the magnet and has a maximum moving distance so that the seat moves relative to the base,
wherein a width of the hollow portion is equal to or greater than twice the maximum moving distance.

2. The image blur connection device as claimed in claim 1, wherein the second length is smaller than the fourth length, the coil moves relative to the magnet in the second direction, and a difference between the second length and the fourth length is greater than or equal to the maximum moving distance.

3. The image blur connection device as claimed in claim 2, wherein the first length is smaller than the third length and a difference between the first length and the third length is greater than or equal to the maximum moving distance.

4. The image blur connection device as claimed in claim 1, wherein the magnet comprises an N pole and an S pole, disposed in the first direction.

5. The image blur connection device as claimed in claim 1 further comprising a Hall element disposed on either the base or the seat and adjacent to the coil, wherein a magnetic force is generated between the coil and the magnet by providing a voltage to the coil, moving the seat in the first direction.

6. The image blur connection device as claimed in claim 1 further comprising a guide member by which the seat is joined to the base, and movable relative to the base in the first direction.

7. The image blur connection device as claimed in claim 6, wherein the guide member comprises:
a plurality of holding portions disposed on the base and the seat, respectively; and
a pair of parallel shafts held by the holding portions, whereby the seat is joined to the base, and movable along the shaft.

8. The image blur connection device as claimed in claim 1, wherein the seat further comprises:
a movable plate movably disposed on the seat; and
a circuit board joined to the movable plate, whereby the image detecting unit is electrically connected to the circuit board and fixed on the base.

9. The image blur connection device as claimed in claim 1, wherein when the image detecting module is still, two halves of the Hall element are located on the N pole and the S pole of the magnet, respectively.

10. An image blur connection device, comprising
a base;
a seat disposed on the base;
an image detecting unit disposed on the seat;
at least one coil disposed the base, having a first length in a first direction and a second length in a second direction, and having a hollow portion, wherein the first direction is perpendicular to the second direction; and
at least one magnet disposed on the seat and opposite to the coil, and having a third length in the first direction corresponding to the first length and a fourth length in the second direction corresponding to the second length, wherein the coil moves relative to the magnet and has a maximum moving distance so that the seat moves relative to the base,
wherein a width of the hollow portion is equal to or greater than twice the maximum moving distance.

11. The image blur connection device as claimed in claim 10, wherein the second length is smaller than the fourth length, the coil moves relative to the magnet in the second direction, and a difference between the second length and the fourth length is greater than or equal to the maximum moving distance.

12. The image blur connection device as claimed in claim 11, wherein the first length is smaller than the third length and a difference between the first length and the third length is greater than or equal to the maximum moving distance.

13. The image blur connection device as claimed in claim 10, wherein the magnet comprises an N pole and an S pole, disposed in the first direction.

14. The image blur connection device as claimed in claim 10 further comprising a Hall element disposed on either the base or the seat and adjacent to the coil, wherein a magnetic force is generated between the coil and the magnet by providing a voltage to the coil, moving the seat in the first direction.

15. The image blur connection device as claimed in claim 10 further comprising a guide member by which the seat is joined to the base, and movable relative to the base in the first direction.

16. The image blur connection device as claimed in claim 15, wherein the guide member comprises:
a plurality of holding portions disposed on the base and the seat, respectively; and
a pair of parallel shafts held by the holding portions, whereby the seat is joined to the base, and movable along the shaft.

17. The image blur connection device as claimed in claim 10, wherein the seat further comprises:
a movable plate movably disposed on the seat; and
a circuit board joined to the movable plate, whereby the image detecting unit is electrically connected to the circuit board and fixed on the base.

18. The image blur connection device as claimed in claim 10, wherein when the image detecting module is still, two halves of the Hall element are located on the N pole and the S pole of the magnet, respectively.
